(19) United States
(12) Patent Application Publication
(10) Pub. No.: US 2001/0014133 A1
(43) Pub. Date: Aug. 16, 2001

(54) Syncronization of a receiver with a base station in a telecommunication system of the TDMA type

(76) Inventor: Agnes Taverdet, Allonnes (FR)

Correspondence Address: Corporate Patent Counsel, U.S. Philips Corporation, 580 White Plains Road, Tarrytown, NY, 10591, US

(21) Appl. No.: 09/756,935

(22) Filed: Jan. 9, 2001

(30) Foreign Application Priority Data
Jan. 11, 2000 (FR) 0000290

(51) Int. Cl. H04L 7/00

(52) U.S. Cl. 375/354; 370/503

(57) ABSTRACT

The present invention describes a synchronizing method and device enabling a receiver to adjust its time base to that of a base station. Such a device includes a frequency synthesizer programmed to one of the operating frequencies of the system; storage means STO having m locations REG1 to REGm and enabling the TDMA frames transmitted by the base station to be stored; correlation means COR which calculate in parallel products of the correlation of a part of the contents of the locations with a portion of a synchronization message containing the synchronization word SYNC; and a controller CONT which interrupts the correlation means as soon as a synchronization message containing a base station identification recognized by the receiver is found, and which ensures the synchronization of said receiver with the base station, which is effected on the basis of the determination of the position of the synchronization message in the location of the receiver. In the case of failure, the synchronizing method is re-started with a new frequency, which proceeds until a base station identification recognized by the receiver is obtained.

### DESCRIPTION

The present invention relates to a method of synchronizing a receiver with a base station in a telecommunication system of the TDMA type.

It also relates to a receiver including a synchronization device which enables said receiver to synchronize with a base station in a telecommunication system of the TDMA type.

Finally, it also relates to a telecommunication system of the TDMA type including at least one receiver and at least one base station.

The invention has many applications, particularly in wireless digital telecommunication systems, for example of the DECT type, but also in mobile radio communication systems of the GSM type.

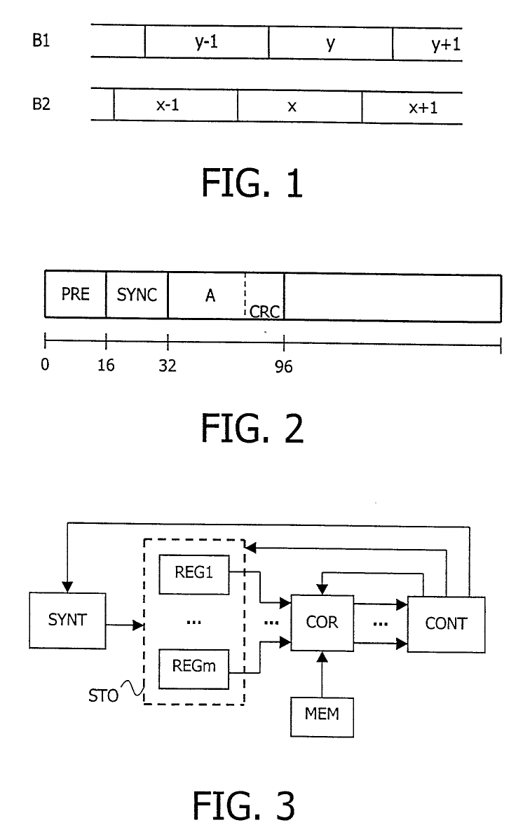

The telecommunication system in accordance with the invention uses TDMA frames. Each frame is a multiplex of a plurality of time slots. In the case of a DECT system, for example, each frame has a duration of 10 ms and contains 24 time slots having a length of 480 bits each. The time bases of the base station (B1) and of the receiver (B2) are initially desynchronized, as is illustrated in FIG. 1, a time slot (x) of the received TDMA frame being shifted in time with respect to the corresponding time slot (y) of the transmitted TDMA frame.

In order to adjust the time base of the receiver to that of the base station, which serves as a reference, the base station of such a system sends a synchronization message over a channel at least once per frame. A channel is the combination of a time slot and an operating frequency of the system, a system of the DECT type generally using 10 frequencies. The structure of a synchronization message of a DECT system is given by way of example in FIG. 2. This message comprises the following fields:

a preamble PRE having a length of 16 bits,

a synchronization word SYNC also having a length of 16 bits,

a field A including one check word CRC and having a total length of 64 bits.

Synchronization is possible when such a synchronization message is detected and when this message contains base station identification which is recognized by the receiver.

Various synchronization methods have already been used for telecommunication systems of the TDMA type, for example those disclosed in the British patent specification GB 2 286 949 A. Such a synchronization method enables a receiver to synchronize with a base station upon the detection of a synchronization message having a structure which differs from that of the message shown in FIG. 2. In the cited prior art, each time slot of the TDMA frame actually contains a part of the synchronization word and the complete synchronization word cannot be detected as long as the entire TDMA frame has not been received.

In the telecommunication system which is at issue here the synchronization word is accommodated in a single time slot of the transmitted TDMA frame, as a result of which the prior-art method cannot be applied.

It is an object of the invention to solve this problem by proposing a reliable and effective synchronization method adapted to the structure of the synchronization message of the telecommunication system at issue here.

To this end, the present invention proposes a synchronization method comprising:

a step of storing TDMA frames transmitted by the base station in m time slots of the receiver,

a correlation step which calculates in parallel products of the correlation of a part of the contents of time slots of the receiver with at least a portion of a synchronization message,

a supervision step, which interrupts the correlation step as soon as a synchronization message containing a base station identification known to the receiver is found in a time slot of said receiver, and which determines a position of the synchronization message in said time slot,

a step of synchronizing the receiver with the base station based on the determination of the position of the synchronization message in the time slot of the receiver.

Such a synchronization message is reliable and effective, particularly in a disturbed environment with a plurality of base stations and a plurality of receivers, owing to the parallel scanning of different time slots.

The present invention also proposes a synchronization method in which the supervision step receives a result of the correlation step within a correlation window CW in n successive sub-steps, n being strictly greater than 1, the width of the correlation window being greater than a reference value equal to an integral valued of the ratio of the total number of bits of a time slot divided by n, and the contents of the time slots of the receiver being shifted to the left of the reference value in each sub-step.

This improves the effectiveness of the method, this method enabling a whole time slot to be scanned.

Finally, the invention relates to a receiver which can take advantage of the implementation of such a method and to a telecommunication system of the TDMA type including at least one such receiver.

These as well as other more detailed aspects will become apparent from the following description of a number of embodiments of the invention, given by way of non-limitative example, with reference to the accompanying drawings, in which:

FIG. 1 illustrates the desynchronization of the time bases of the receiver and the base station,

FIG. 2 shows the structure of a synchronization message in a telecommunication system of the TDMA type,

FIG. 3 diagrammatically shows a receiver including a synchronization device in accordance with the invention,

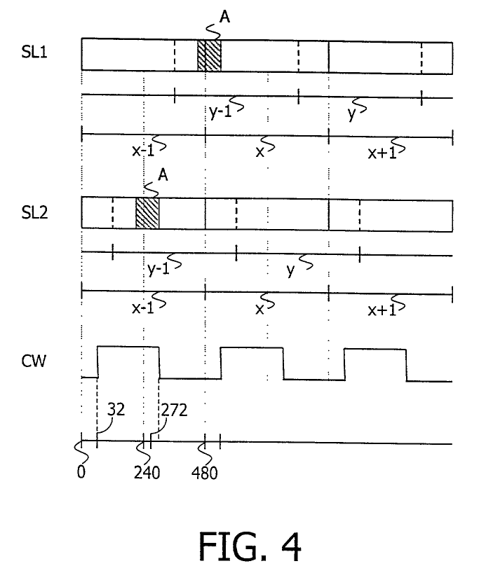

FIG. 4 shows an embodiment using a method of scanning a TDMA frame in two intervals of a TDMA frame,

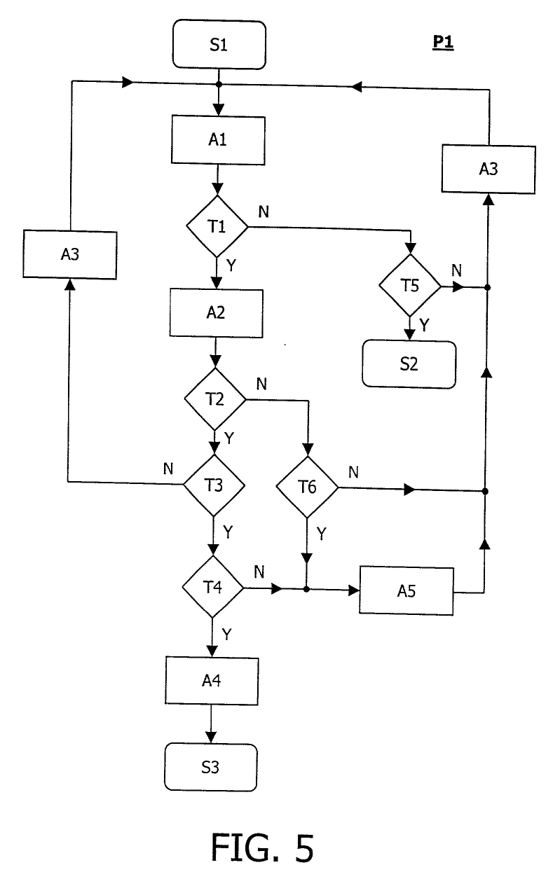

FIG. 5 is a flow chart representing the synchronization method applied to portion of a time slot of the receiver,

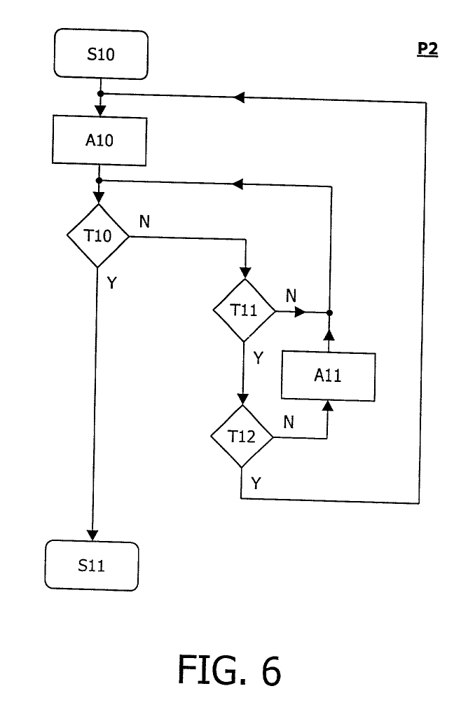

FIG. 6 is a flow chart representing the process of scanning a TDMA frame in n intervals and of frequency scanning in accordance with the synchronization method according to the invention.

The following description relates to a telecommunication system of the DECT type. However, it will be evident to one skilled in the art that the proposed synchronization method may also be applied to any other synchronous telecommunication system of the TDMA type.

The synchronization method in accordance with the invention enables a receiver to find a base station and to adjust its time base to that of said base station. To this end, the receiver includes a synchronization device which comprises the following elements, which are shown diagrammatically in FIG. 3.

First of all, a frequency synthesizer SYNT is programmed to one of the operating frequencies of the telecommunication system. To carry out the method in accordance with the invention the synthesizer operates in a closed loop. Thus, the frequency reception remains stable over a period of time at least equal to the duration of one frame.

Storage means STO of the receiver have m locations (m=24 for a DECT system) which serve to transmit or receive information and which are used here for receiving. These locations, also referred to as time slots of the receiver, are for example registers REG1 to REGm and enable the TDMA frames transmitted by the base station to be stored.

Correlation means subsequently calculate in parallel correlation products of a part of the contents of the time slots of the receiver with at least a portion of a synchronization message. In the preferred embodiment the portion of the synchronization message corresponds to the synchronization word SYNC which has a length of 16 bits for a DECT system and which is stored in a memory MEM in the present case.

Supervision means control the correlation means and interrupt said means as soon as a synchronization message containing the synchronization word SYNC has been detected in a time slot of the receiver. These supervision means subsequently verify that the field A, which has a length of 64 bits for a DECT system and which follows the synchronization word, contains a check word CRC as well as a base station identification known to the receiver. If no synchronization message having these three elements (synchronization word, check word and a known base station identification) is found the synthesizer is programmed to a new frequency and the synchronization method proceeds until a correct base station is obtained. In the preferred embodiment the frequencies are scanned in an ascending order but they may also be scanned in another order. When a station is found the supervision means determine the position of the synchronization message in the time slot of the receiver.

Synchronization means then shift the time base of the receiver by the number of bits corresponding to this position so as to adjust it to that of the base station.

In the preferred embodiment the supervision and synchronization means are realized by means of a controller CONT. This controller is, for example, the Philips controller PCD801X. By means of such a device the time base of the receiver can be shifted by one bit and the position of the synchronization message in the time slot of the receiver can be determined. In the preferred embodiment the controller uses a correlation window CW. When a synchronization word is detected in one of the registers REG1 to REGm and within this window CW, the 64 bits following the last bit of the synchronization word are processed by the controller.

The correlation window CW may begin starting from bit 32 of a time slot of the receiver, which corresponds to a preamble and a synchronization word positioned at bit 0 to bit 31. It should end before bit 416: in the case of a time slot comprising 480 bits, the receiver should be able to read the whole field A, which is 64 bits, in order to ascertain that the contents of this field is valid.

If the field A of the synchronization message is divided between two time slots (x-1 and x) of the receiver (see FIG. 4), the latter will not be able to detect said message with the correlation window described above. In order to overcome this problem a method of scanning in two intervals is used. In a first interval SL1 only one half of each of the time slots of the receiver is scanned, which is effected with the aid of a correlation window CW which starts at bit 32 and ends at bit 272. In practice, some additional bits are added to the upper limit of the correlation window CW, as indicated in FIG. 4, in order to allow for a possible drift of the receiver time base. If no synchronization message having the three key elements is found, the controller shifts the contents of the registers to the left over a length equal to half a time slot, i.e. 240 bits in the present case. Since the position of the correlation window remains unchanged the half of the new time slot of the receiver thus obtained is then scanned in a second interval SL2. This method thus enables a TDMA frame to be scanned in its entirety.

In general terms, this method uses n successive scans with a correlation window CW whose width is equal to the whole value of the division of 480 by n to which some additional bits are added. If no synchronization message having these three key elements is found, the controller shifts the contents of the registers to the left over a length equal to the whole value of the division of 480 by n, which is effected until a valid synchronization message is obtained or the scan of the TDMA frame is completed.

The synchronization methods currently used in telecommunication systems of the DECT type employ a search for the synchronization message in different time slots, which is effected sequentially in the different channels (240 in the DECT system). Two search modes are possible:

either by sequentially scanning the channels arranged in a descending order of a power value measured in the proximity of the receiver,

or by sequentially scanning the time slots for the different operating frequencies that are possible.

On the one hand, the use of the method in accordance with the invention enables the search time for synchronization to be reduced, since the sequential frequency scanning mode can be very long, particularly if the base station transmits the synchronization message at the last frequency scanned. On the other hand, the synchronization method in accordance with the invention has a better reliability in comparison with the channel scanning mode. As a matter of fact, the synchronization may fail in a disturbed environment when the receiver time slot which contains the synchronization message is tested a long time after the power measurement has been carried out, a shift between the time base of the receiver and that of the base station being produced. Moreover, in these two sequential scanning modes the receiver time base can be forced upon that presumed for a base station each time that a synchronization message is found. However, if this message does not contain a correct identification for the base station the time base must be restored, which prolongs the search time.

FIG. 5 is a flow chart which represents the synchronization method applied to a portion of the time slot of the receiver in accordance with the inventive synchronization method. The flow chart P1 comprises the following steps and tests:

First of all, the search for synchronization between the receiver and a base station is started (initial state S1).

This is followed by a correlation step (A1) between the content of the portion of the time slot and the synchronization word SYNC.

A test T1 is applied to the result of the correlation step. If the synchronization word SYNC is detected (Y) within the correlation window CW, the controller performs a processing step (A2) for the 64 bits of the receiver time slot which follow the synchronization word and which correspond to the field A; if not (N), a test T5 is carried out.

A test T2 with regard to the result of the comparison step is then carried out. If a check word CRC has been found during the processing step (Y), a test T3 is carried out; if this is not the case (N) a test T6 is carried out.

The test T3 verifies whether the field A contains an identification of the base station. If this is the case (Y) a test T4 is carried out; if this is not the case (N) the test T3 is followed by a step (A3) of waiting for a new frame to load. When the frame has been loaded the synchronization method starts again with the correlation step (A1).

The test T4 checks the validity of the base station identification. If this identification is recognized by the receiver (Y) a synchronization step (A4) is carried out, the controller determining the position of the synchronization message within the receiver time slot and consequently shifting the time base in order to adjust it to that of the base station; if this is not the case (N), a step (A5) of reducing the size of the correlation window is carried out. The lower limit of the correlation window becomes equal to z, where z is an integer which is strictly higher than the number of the last bit of the synchronization word determined in the receiver time slot. Thus, during loading of the following frame (A3), the method enables the remaining portion of the receiver time slot to scanned where another synchronization word, which now corresponds to synchronization message containing a base station identification recognized by the receiver, can be detected within the correlation window.

The test T5 enables a plurality of correlation tests between the synchronization word and the contents of a portion of the receiver time slot to be carried out, which is effected in order to avoid a possible risk of errors. If the number of tests agreed upon (Y) is reached, the synchronization method is suspended (intermediate state S2) for the portion of the time slot under consideration; if this is not the case (N), the method is restarted at the beginning (A1) after loading of a new frame (A3).

The test T6 enables several comparisons to be made between the check word CRC and the content of the field A. If several tests turn out to be unsuccessful (Y), the correlation window is reduced (A5) in order to scan the remaining portion of the time slot after loading of the following frame (A3); if this is not the case the next frame is scanned with an unchanged correlation window.

Once synchronization is achieved (A4) the synchronization method ends (final state S3) and the tests applied to the 23 other portions of the receiver time slots are discontinued.

In the preferred embodiment the correlation result should be maximal in order to proceed to the next test; conversely, a plurality of tests are carried out. In another embodiment it is also possible to allow an error in the correlation result, for example of one or two units, and to limit the number of tests to be carried out.

FIG. 6 is a flow chart P2 which represents the process of scanning a TDMA frame in n time intervals and of frequency scanning in accordance with the inventive synchronization method.

First of all, the search for synchronization between the receiver and a base station is started (initial state S10), for example by turning on the receiver.

This is followed by a programming step (A10) for the frequency synthesizer SYNT in order to define a first reception frequency.

A test T10 is conducted with regard to the state of the search for synchronization with a base station for the 24 time slot portions. If one of these portions has reached its final state S3 (Y) the scanning process is terminated (S11).

In the opposite case (N) a test T11 is carried out in order to check if all the time slot portions of the receiver have reached the intermediate state S2, which corresponds to the situation that no synchronization word has been detected within the correlation window. If this is the case (Y) a test T12 is carried out; if it is not the case (N) the scanning process returns to the test T10.

The test T12 relates to the number of scanning sub-steps, a TDMA frame being scanned in n successive scanning sub-steps. If this number is equal to n (Y), i.e. if the whole frame has been scanned, the scanning process is re-started at the beginning and a new frequency is tested (A10).

In the opposite case (N) a step of shifting the contents of the registers (A11) is effected by the controller, the shift being each time equal to an integral value of the division of 480 by n, and the scanning process returns to the test T10.

It is to be noted that the use of the verb “to comprise” does not exclude the presence of any steps or elements other than those defined in a claim.

1. A method of synchronizing a receiver with a base station in a telecommunication system of the TDMA type, comprising:
a step of storing TDMA frames transmitted by the base station in m time slots of the receiver,
a correlation step which calculates in parallel products of the correlation of a part of the contents of time slots of the receiver with at least a portion of a synchronization message,
a supervision step, which interrupts the correlation step as soon as a synchronization message containing a base station identification known to the receiver is found in a time slot of said receiver, and which determines a position of the synchronization message in said time slot,
a step of synchronizing the receiver with the base station based on the determination of the position of the synchronization message in the time slot of the receiver.

2. A synchronizing method as claimed in claim 1, in which the storage and correlation steps are reiterated for different frequency values until the synchronization message containing a base station identification known to the receiver is determined by the supervision step.

3. A synchronizing method as claimed in claim 1, in which the supervision step receives a result of the correlation step within a correlation window CW in n successive sub-steps, n being strictly greater than 1, the width of the correlation window being greater than a reference value equal to an integral valued of the ratio of the total number of bits of a time slot divided by n, and the contents of the time slots of the receiver being shifted to the left of the reference value in each sub-step.

4. A synchronizing method as claimed in claim 1, in which the supervision step receives a result of the correlation step within a correlation window CW starting after a bit of a time slot of the receiver, the number of said bit being that of the last bit of the synchronization word in the synchronization message, and ending before a bit of a similar time slot of the receiver, whose bit number corresponds to the difference between a total number of bits of a time slot and a number of bits of a field containing the base station identification.

5. A synchronizing method as claimed in any one of the claims 3 and 4, including a step of reducing the correlation window, said window starting with a bit whose number is strictly greater than the number, in a time slot of the receiver, of the last bit of the synchronization word of a preceding synchronization message that is not valid.

6. A receiver including a synchronization device which enables said receiver to synchronize with a base station in a telecommunication system of the TDMA type, and including:
means STO for storing TDMA frames transmitted by the base station in m locations,
correlation means COR which calculate in parallel products of the correlation of a part of the contents of time slots of the m locations with at least a portion of a synchronization message,
a controller CONT which interrupts the calculation of the correlation means as soon as a synchronization message containing a base station identification known to the receiver is found in a location, and which determines the position of said synchronization message in the location in order to synchronize the receiver with the base station.

7. A receiver as claimed in claim 6, including a frequency synthesizer SYNT, which is programmable to different operating frequencies of the telecommunication system and whose controller programs a new frequency as long as no synchronization message containing a base station identification known to the receiver is found in a location of said receiver.

8. A receiver as claimed in claim 7, in which the frequency synthesizer operates in a closed loop so as to ensure the stability of the reception frequency over a period of time which is at least equal to the duration of a frame.

9. A telecommunication system of the TDMA type including at least one receiver as claimed in claim 6 and at least one base station.
